(19) United States
(12) Patent Application Publication
(10) Pub. No.: US 2024/0046362 A1
(43) Pub. Date: Feb. 8, 2024

(54) SYSTEM AND METHOD FOR CONFIGURING AN INSURANCE POLICY WITH DIGITAL ASSETS

(71) Applicants: James Eason, Raliegh, NC (US); Michael Casey, Alexandria, VA (US); Kenneth Leibow, Raliegh, NC (US)

(72) Inventors: James Eason, Raliegh, NC (US); Michael Casey, Alexandria, VA (US); Kenneth Leibow, Raliegh, NC (US)

(21) Appl. No.: 18/129,883

(22) Filed: Apr. 2, 2023

Related U.S. Application Data
(60) Provisional application No. 63/395,490, filed on Aug. 5, 2022.

(51) Int. Cl. G06Q 40/08; G06Q 20/38; G06Q 20/40; G06Q 20/36

(52) U.S. Cl. CPC G06Q 40/08; G06Q 20/381; G06Q 20/40; G06Q 20/389; G06Q 20/3678

(57) ABSTRACT

A computer-implemented method of currency conversion into digital assets includes obtaining authorization to receive a payout in a fiat coin or currency of a first predetermined amount on behalf of at least one beneficiary of an insurance policy. The payout is received and is converted into a first predetermined amount of one or more digital assets that may include cryptocurrency or non-fungible tokens (NFT). The at least one beneficiary is provided with one or more payments of a second predetermined amount.

### CROSS-REFERENCE TO RELATED APPLICATIONS

Applicants claim the benefit of priority from U.S. provisional application No. 63/395,490 filed Aug. 5, 2022, the contents of which are incorporated by reference herein.

### BACKGROUND

### Technical Field

The present disclosure generally relates to insurtech financial technology systems, and more particularly, to a system and method for configuring digital assets with an insurance policy.

### Description of the Related Art

There are systems in operation for buying, selling, and holding assets. Assets may be physical, such as real estate, precious metals, oil, etc., or digital, such as electronic files, videos, pdfs, token, and cryptocurrencies. For example, there are applications for brokerage and/or retirement accounts in which users can direct their investments in a number of different investments.

Cryptocurrency is a relatively new addition to the field of digital assets, and governments throughout the world are still trying to determine how to regulate them to protect consumers from issues fairly common to all digital assets. Accordingly, some areas of investment and insurance have been slow in adapting to these types of digital assets. The explosive growth in digital assets is being noticed by people who would like to at least partially participate in the ownership of such digital assets and do so with a trusted institution such as their life insurance carrier.

Insurance is one particular industry that has not yet embraced the use of digital assets. By law in most states, death benefits claims for life insurance policies are required to be paid “in coin or currency”. Thus, only fiat currencies or coins can be used to pay the proceeds of a life insurance claim. The insurance policy holder is often providing replacement income for dependents, and would like to exercise some control over how the proceeds will be distributed. One way to accomplish this control of the proceeds is by setting up a trust that is funded with the insurance proceeds. However, trusts can be complicated and expensive to set up, and the beneficiaries may have to interact with a trustee to receive payments, generating trustee fees that will come out of the proceeds. Accordingly, there is a need to permit insurance proceeds to be used for digital assets while still in compliance with state laws and/or regulations that require the insurance proceeds to be paid in coin or currency.

### SUMMARY

In one embodiment, a computer-implemented method of currency conversion into digital assets includes obtaining authorization to receive a payout in a fiat coin or currency of a first predetermined amount on behalf of at least one beneficiary of an insurance policy. The payout is received and converted into a first predetermined amount of one or more digital assets that may include cryptocurrency or non-fungible tokens (NFT). The at least one beneficiary is provided with one or more payments of a second predetermined amount.

In an embodiment, the obtaining of authorization to receive the payout in the first determined amount and to convert the payout into digital assets is provided by executing a rider to an existing insurance policy.

In an embodiment, the existing insurance policy and the executed rider is stored on a blockchain.

In an embodiment, the existing insurance policy and the executed rider is stored as a non-fungible token (NFT) in a consumer digital asset wallet.

In an embodiment, the obtaining of authorization to receive the payout in the first determined amount and to convert the payout into digital assets is provided by an executed rider to a new insurance policy.

In an embodiment, the new insurance policy and the executed rider is stored on a blockchain.

In an embodiment, the new insurance policy and the executed rider is stored as a non-fungible token (NFT) in a consumer digital asset wallet.

In an embodiment, the digital assets of the payout are stored in one or more blockchains.

In an embodiment, the digital assets of the payout are stored in a digital wallet.

In an embodiment, receiving one or more over-premium payment amounts from an insurance company or its designee for the at least one beneficiary of the insurance policy, and

In an embodiment, the conversion of the one or more over-premium payments into digital assets are held in a respective account created for each of the at least one beneficiary. The over-premium payments are added to the value of the received payout that is provided to the at least one beneficiary in the form of one or more payments.

In an embodiment, the providing of the at least one or more payments of the second predetermined amount is performed in response to a request of the at least one beneficiary or the owner of the insurance policy, and the second predetermined amount may be one of a fraction, a percentage, or a fixed amount that is less than the first predetermined amount.

In an embodiment, the providing of the second predetermined amount includes providing a lump sum payout substantially equal to the first predetermined amount.

In an embodiment, the converting of the payout into digital assets comprises electronically sending the fiat coin or currency to a cryptocurrency custodian and requesting conversion of the fiat coin or currency into at least one designated cryptocurrency and/or a non-fungible token (NFT).

In an embodiment, the converting of the payout into digital assets includes electronically communicating instructions and the payout of the first predetermined amount of fiat coin or currency to a cryptocurrency custodian to convert the fiat coin or currency into cryptocurrency.

In an embodiment, the converting of the payout into digital assets comprises converting the fiat coin or currency payout into one or more of Bitcoin®, Litecoin®, or Non-Fungible Tokens.

In an embodiment, the providing of the one or more payments to the beneficiary are made in a fiat coin or currency.

In an embodiment, the providing of the one or more payments to the beneficiary is made in a cryptocurrency.

In one embodiment, a computer implemented method of currency conversion into digital assets include receiving by one or more processors of an insurtech entity an electronic communication including a rider to an insurance policy that authorizes receiving a payout in a fiat coin or currency of a first predetermined amount on behalf of at least one beneficiary of an insurance policy. An indication is received that the payout from the insurance policy has been transferred to an account controlled by the one or more processors of the insurtech entity, and the payout is then forwarded from the insurtech entity to a cryptocurrency qualified custody account that converts the payout into one or more digital assets held in an account on behalf of the at least one beneficiary of the insurance policy.

In an embodiment, the cryptocurrency custodian stores the digital assets in a digital wallet, and further comprising sending by the insurtech entity over-premium payments to the cryptocurrency custodian for conversion to digital assets and holding in the account on behalf of the at least one beneficiary of the insurance policy.

In an embodiment, the cryptocurrency custodian electronically sends the digital assets to the insurtech entity for storage online in a digital wallet or offline in an electronic ledger.

In an embodiment, in response to receiving a request from the at least one beneficiary, one or more payments of a predetermined amount are provided from the account held on behalf of the at least one beneficiary of the insurance policy.

In an embodiment, in response to receiving a request from the at least one beneficiary, one or more payments are provided of a predetermined amount from the account held on behalf of the at least one beneficiary of the insurance policy.

In one embodiment, a computing device for converting currency into digital assets includes one or more processors, and a memory coupled to the one or more processors. The memory stores non-transitory executable instructions to cause the processor to perform acts including: obtaining an authorization to receive a payout in a fiat coin or currency of a first predetermined amount on behalf of at least one beneficiary of an insurance policy. The payout is received and converted into the first predetermined amount of one or more digital assets. The at least one beneficiary is provided with one or more payments of a second predetermined amount based on a current value of the one or more digital assets.

In an embodiment, the instructions cause the processor to perform additional acts including receiving one or more over-premium payment amounts from an insurance company or its designee for the at least one beneficiary of the insurance policy. The one or more over-premium payments are converted into digital assets held in a respective account created for each of the at least one beneficiary. The second predetermined amount includes a current value of the received one or more over-premium payments plus the insurance payout amount that is provided to the at least one beneficiary in the form of one or more payments.

In an embodiment, the converting of the payout into digital assets includes executable instructions to cause the one or more processors to perform additional acts including electronically communicating instructions and providing the payout of the first predetermined amount of fiat coin or currency to a cryptocurrency custodian to convert the fiat coin or currency into cryptocurrency.

In an embodiment, the converting of the payout into digital assets includes converting the fiat coin or currency into one or more designated cryptocurrency and/or non-fungible token (NFT).

In one embodiment, a non-transitory computer-readable storage medium tangibly embodying a computer-readable program code having computer-readable instructions that, when executed, causes a computer device to carry out a method of the method including obtaining authorization to receive a payout in a fiat coin or currency of a first predetermined amount on behalf of at least one beneficiary of an insurance policy. One or more over-premium payment amounts are received from an insurance company or its designee for the at least one beneficiary of the insurance policy and converting the over-premium payment amounts amount into one or more digital assets held in a respective account created for each of the at least one beneficiary. The payout is received from the insurance company in a fiat coin or currency of a first predetermined amount on behalf of at least one beneficiary of an insurance policy and converting the first predetermined amount into the one or more digital assets. In response to receiving a request, providing the at least one beneficiary with one or more payments of a second predetermined amount that includes a least a portion of the over-premium payments and the payout of the insurance policy in a form of one or more of a cryptocurrency and/or a fiat coin currency.

### BRIEF DESCRIPTION OF THE DRAWINGS

The drawings presented herein show illustrative embodiments of the disclosure. They do not illustrate all embodiments. Other embodiments may be used in addition to or instead of the illustrative embodiments. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps. The drawings are not intended to depict every feature of every implementation nor relative dimensions of the depicted elements, and are not drawn to scale.

FIG. 1 illustrates is an overview of the components of a computing device used to perform operations of the configuring of an insurance policy with digital assets, consistent with an illustrative embodiment.

FIGS. 2A and 2B are a flow diagram showing an overview of the operations of the configuring of an insurance policy with digital assets, consistent with an illustrative embodiment.

FIG. 3 is a flowchart illustrating a computer-implemented method of configuring of an insurance policy with digital assets, consistent with an illustrative embodiment.

FIG. 4 is a process flow illustrating how NFTs are created and stored on a blockchain.

### DETAILED DESCRIPTION

In the following description, numerous specific details are set forth to clearly describe various specific embodiments disclosed herein. One skilled in the art, however, will understand that the subject matter of the present disclosure may be practiced without all of the specific details discussed below. In other instances, well-known features may not have been described so as not to obscure the teachings of the present disclosure with unnecessary detail regarding known features.

As used herein, the term “and/or” is to be interpreted broadly is to be understood to refer to all or some of the elements. For example, “at least one of (a) and/or (b) means the teaching pertains only to element (a), or only to element (b), or to both element (a) and element (b). In another example, “at least one of (a), (b), and/or (c), means the teaching pertains to only element (a), or only to element (b), or only element (c), or to elements (a) and (b), elements (a) and (c), elements (b) and (c), or to all of (a), (b) and (c).

As used herein the term “digital asset” is to be interpreted broadly and is to be understood to refer to cryptocurrency, non-fungible tokens, etc.

As used herein, the term “at least one beneficiary” may refer to one or more persons, or a trust, or the trustee or designee of a trust. The at least one beneficiary may be the estate of an insurance policy owner. The aforementioned is not exhaustive in terms of the type of beneficiary.

As used herein, the term “insurtech” refers to an entity or application of data science related to the insurance industry. For example, claims processing, the use of technology for event monitoring instead of or in addition to claim filing, claim payment. Insurtech may include the use of blockchains, smart contracts and tracking. An insurtech entity may be a designated third-party designee to receive a fiat coin or currency insurance payout on behalf of a beneficiary of an insurance contract. Typically, a “rider” to the insurance contract provides authorization to the insurtech entity to receive the fiat coin or currency payout (as typically required by law or regulation) so that the payout from the insurance company is complete. An insurtech entity may receive periodic or demand payments on behalf of the beneficiary in the form of fiat coin or currency directly from the insurance company.

As used herein, the term “over-premium” payment refers to additional funds paid to an insurance company that exceeds the premium payment. These over-premium payments, as agreed to in an insurance contract, are transferred to the qualified custody account by the insurance company for the benefit of the beneficiary of the insurance policy. Over-premium payments may be forward to a third part entity, such as an insurtech entity for investment. The insurtech entity may communicate and send funds to/from a cryptocurrency custodian. Funds may be held in a digital wallet by the cryptocurrency custodian, or by the insurtech entity. The cryptocurrency funds may also be stored offline in a ledger for enhanced security. The funds may also be stored in a blockchain.

Also, it is to be understood that the phraseology and terminology used herein is for the purpose of description and should not be regarded as limiting. The use of “including,” comprising, “or “having” and variations thereof herein is meant to encompass the items listed thereafter and equivalents thereof as well as additional items. Unless limited otherwise, the terms “connected,” coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the present disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the present disclosure may be implemented in software. As such, it should be noted that a plurality of hardware and software-based devices, as well as a plurality of different structural components may be utilized to implement the subject matter of the present disclosure. Furthermore, and as described in subsequent paragraphs, the specific mechanical configurations illustrated in the drawings are intended to exemplify embodiments of the subject matter of the present disclosure.

### Overview

The teachings of the present disclosure provide for an improvement in the insurtech field, and provide for an improvement in computer technology. For example, while the owners of insurance policies often express interest in at least a portion of their insurance proceeds to be paid in digitals assets (including but not limited to cryptocurrency and non-fungible tokens), heretofore there was no way to permit purchase such digital assets due to insurance laws and regulations. The beneficiary may lack the sophistication to invest in digital assets, but the owner of the policy may in fact embrace digital assets. Through the computer-implemented method of the present disclosure, the digital assets purchases may be fulfilled and ensure compliance with applicable laws and regulation of insurance. The computer-implemented method may also provide for a more efficient approach with a reduction in computer processing and storage. In addition, the disclosure is directed to a rider for an existing or a new insurance policy in which currency is converted into digital assets. The currency may include the insurance payout, and/or “over premium” payments made specifically for the purpose to obtain digital assets.

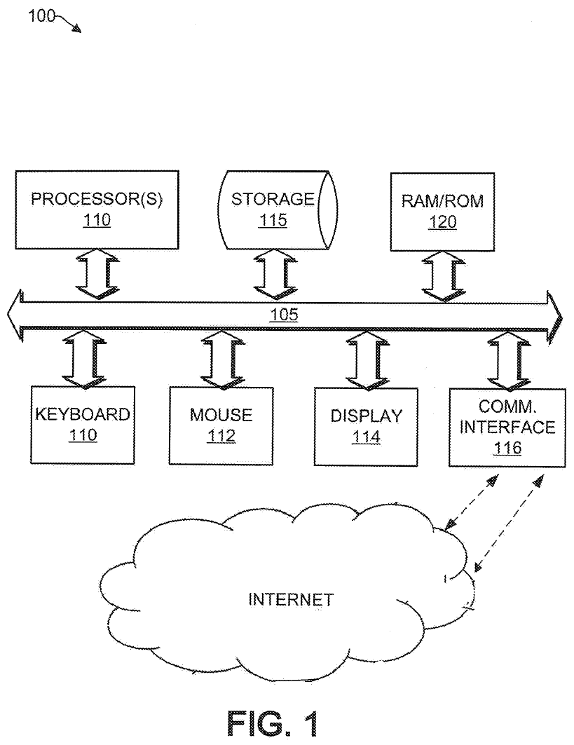

FIG. 1 illustrates is an overview of the components of a computing device used to perform operations of the configuring of an insurance policy with digital assets, consistent with an illustrative embodiment. It is to be understood that the components shown in FIG. 1 are provide for illustrative purposes, and the present disclosure is not limited to the arrangement shown. A number of the components shown are optional, and there may be few components arranged differently than shown.

With reference to FIG. 1, a computing device 100 with one or more buses 105 enables one or more processors 110 configured with software to communicate with various components. The computing device 100 may be one or more servers, but the appended claims are not limited to being embodied as a server.

The storage 115 may be an optical storage, and/or may include more conventional HDD storage. The storage 115 may include cache memory, and may include data stores. RAM/ROM 120, a keyboard 110, a mouse 112, a display 114, and a communication interface 116 are connected to the bus 105. The communication interface 116 may be connected to a router, and may be transmitted by any known wired or wireless communication to users via the Internet. The present disclosure is not limited to any particular communication protocol. The computing device 100 may be used to communicate with an insurance company, underwriter, etc. Clients using an app may access their account information via the communication interface 116.

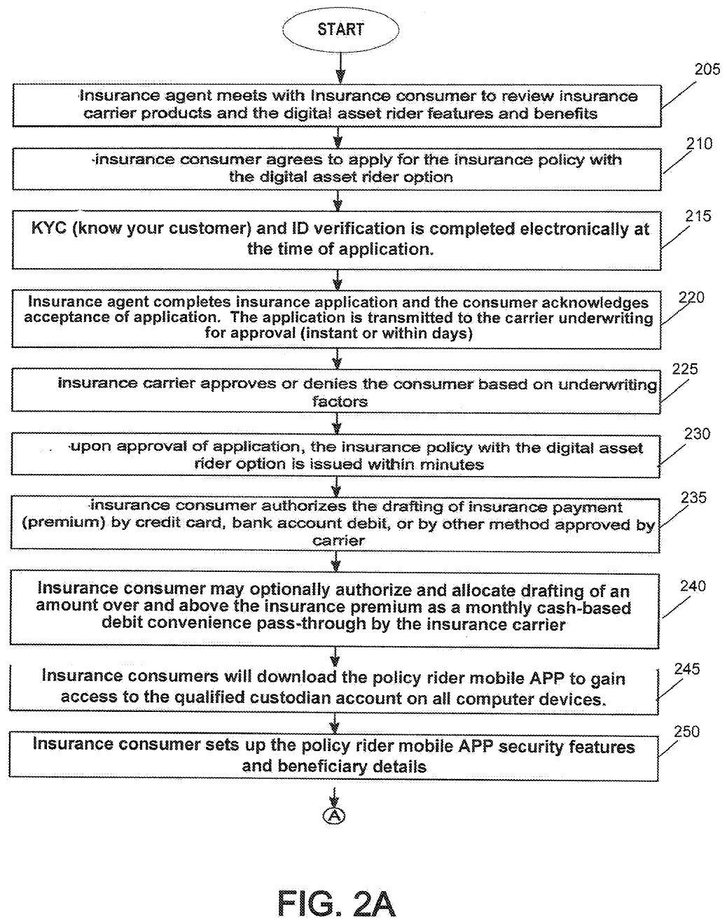

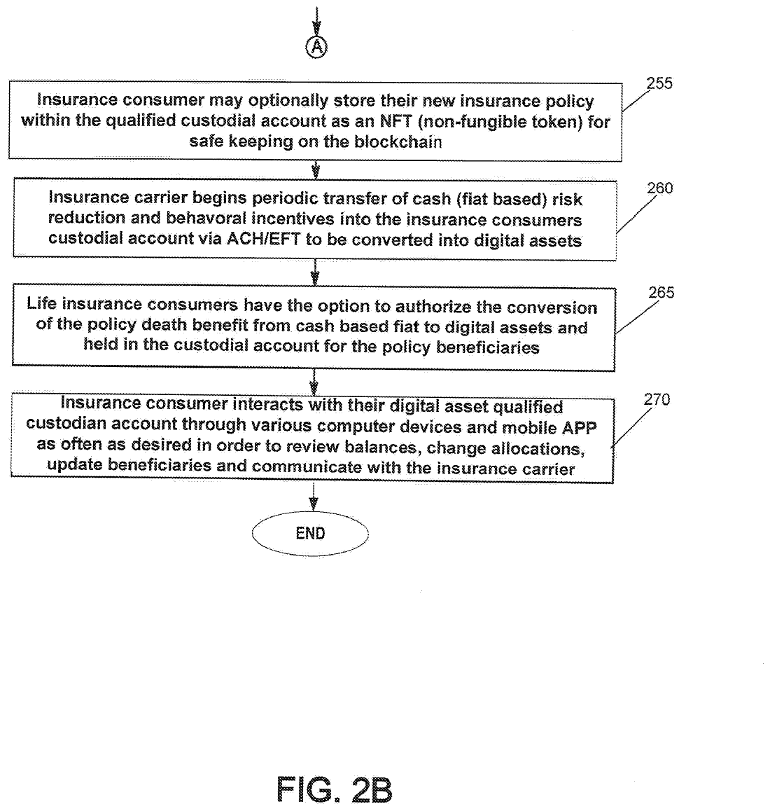

An overview of a first illustrative embodiment of the present disclosure will now be discussed in accordance with FIGS. 2A and 2B. It is to be understood that the flow operations shown in FIGS. 2A and 2B provided for illustrative purposes, are not required to be performed in the order shown and described herein, and some of the operations discussed herein are optional.

At operation 205, an insurance agent may meet (in person or via electronic methods such as Zoom) with an insurance consumer to review insurance carrier products and discuss the digital asset rider feature and benefits.

At operation 210, the insurance consumer agrees to apply for the insurance policy by executing the digital asset rider option to an existing or new insurance policy.

At operation 215, there is a security operation performed. For example, the term “KYC” (know your customer) and ID verification are completed electronically at the time of application if the consumer has elected the digital asset rider option.

At operation 220, the insurance agent completes the insurance application, the consumer signs the application, and the application is transmitted to the carrier underwriting for approval. The approval may be virtually instantaneous or occur within days.

At operation 225, the insurance carrier approves or denies the consumer based on underwriting factors. Sometimes an insurance score is checked, and/or there may be a proprietary process with regard to approval.

At operation 230, upon approval of the application, the insurance policy with the digital assets rider is issued, typically within minutes.

At operation 235, the insurance consumer authorizes the drafting of an insurance payment (e.g., a premium) by a form of payment approved by the carrier. For example, credit card, debit card, checking account (ACH), and/or one of the online payment forms such as Paypal®, Venmo®, Zelle®, etc., are some non-exhaustive examples.

At operation 240, the insurance consumer optionally authorizes and allocates drafting of an amount above the premium (“over-premium”) as periodically (e.g., monthly) cash-based debit convenience pass-thru by the insurance carrier to be fully allocated to a custodial account for the conversion to digital assets.

At operation 245, the insurance consumers may download a policy rider mobile application (e.g., an App) to gain access to the qualified custodial account on all computer devices.

At operation 250, the insurance consumer may set up the policy rider App security features and beneficiary details. For example, a policy number, social security number, custodial beneficiary designation for conversions.

At operation 255, the insurance consumer may optionally have their new insurance policy stored within the qualified custodial account as a non-fungible token (NFT) for safekeeping on the blockchain.

At operation 260, the insurance carrier may optionally perform a periodic transfer of cash (fiat based) risk reduction and behavioral incentives into the insurance consumers custodial account via ACH/EFT to be converted into digital assets.

At operation 265, insurance policies with digital asset rider have the option to authorize the conversion of the policy death benefit from cash-based fiat to digital assets and held in the custodial account for the policy beneficiaries. The digital assets may be stored in a digital wallet, or stored in a blockchain.

At operation 270, the insurance consumer interacts with the digital assets qualified custodial account through their computer devices and App as often as they desire to review digital asset balances, change allocations, update beneficiaries, communicate with the insurance carrier, etc.

According to some illustrative embodiments, the presently disclosed system may be implemented using a computing device such as, for example, computer, mobile phone, cellular phone, a tablet, and/or a laptop. According to some embodiments, the presently disclosed mobile App may be implemented using a computing device such as, for example, a computer, mobile phone, cellular phone, a tablet, and/or a laptop.

The computing device may have more components or fewer components than described below, may combine two or more components, or a may have a different configuration or arrangement of the components. The various components described below may be implemented in hardware, software or a combination of both hardware and software, including one or more signal processing and/or application-specific integrated circuits.

According to some embodiments, the computing device may have a memory (which may include one or more computer-readable storage mediums), one or more processing units (e.g., CPU's), an audio circuitry, a speaker, in accordance with some embodiments. These components may communicate over one or more communication buses or signal lines.

The memory may include high-speed random-access memory and/or non-volatile memory, such as one or more magnetic disk storage devices, flash memory devices, or other non-volatile solid-state memory devices. Access to memory by other components of the computing device, such as the CPU may be controlled by a memory controller.

The computing device and/or the chip(s) may include a radio frequency (RF) circuitry. The radio frequency (RF) circuitry may be configured to receive and transmit RF signals, also called electromagnetic signals. The RF circuitry converts electrical signals to/from electromagnetic signals and communicates with communications networks and other communications devices via the electromagnetic signals. The RF circuitry may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. While not an exhaustive list, some non-limiting examples of a wireless communication may use any of a plurality of communications standards (such as LTE and 5G), protocols and technologies, including but not limited in any way to a Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Bluetooth Low Energy (LE), Wireless Fidelity (Wi-Fi) IEEE 802.11a, “802.11b, 802.11g” and “802.11n, Voice over Internet Protocol (VoIP), WiBro, WIMAX, Zigbee, infrared, a protocol for email (e.g., Internet message access protocol (IMAP) and/or post 12 office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), Near Field Communication (NFC), or any other suitable communication protocol, including communication protocols not yet developed as of the filing date of this document.

The computing device and/or the chip(s) may further include a power system for powering the various components. The power system may comprise a power management system, one or more power sources (e.g., battery, alternating current (AC)), a recharging system, a power failure detection circuit, a power converter or inverter, a power status indicator (e.g., a light-emitting diode (LED)) and/or any other components associated with the generation, management and distribution of power.

### Computer-Implemented Method

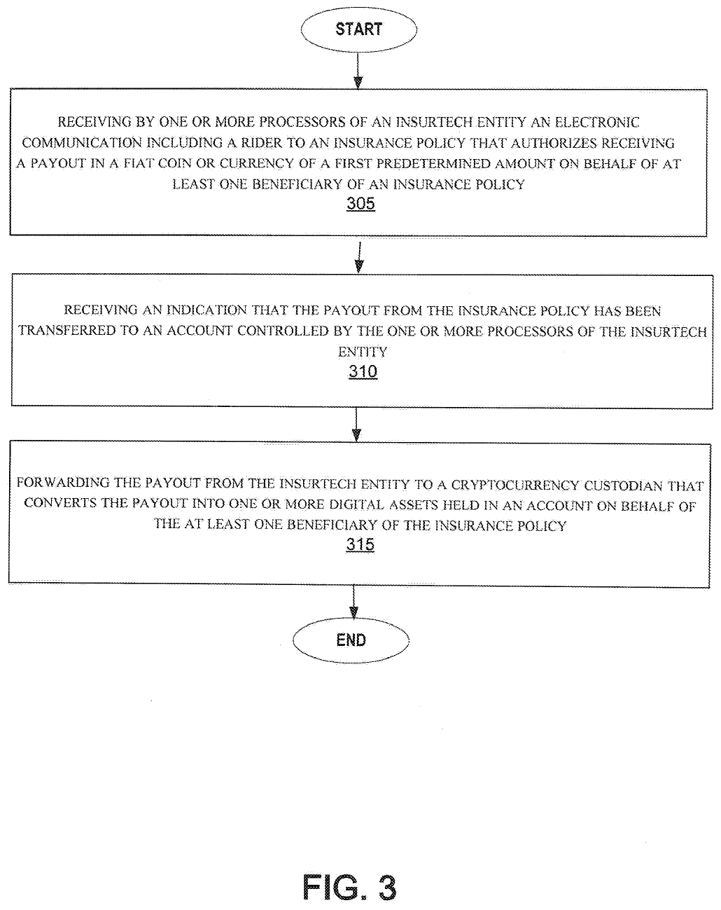

With the foregoing overview of the example architecture, it may be helpful now to consider a high-level discussion of an example process. To that end, FIG. 3 is a flowchart illustrating a computer-implemented method of configuring of an insurance policy with digital assets, consistent with an illustrative embodiment.

FIG. 3 is shown as a collection of blocks, in a logical order, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement data. In each process, the order in which the operations are described is not intended to be construed as a limitation, and any number of the described blocks can be combined in any order and/or performed in parallel to implement the process.

At operation 305, one or more processors (see FIG. 1, processors 110) of a computing device 100 (also shown in FIG. 1) receive an electronic communication (via the communication interface 116) that including a rider to an insurance policy that authorizes receiving a payout in a fiat coin or currency of a first predetermined amount on behalf of at least one beneficiary of an insurance policy.

At operation 310, the computing device 100 receives an indication that the payout from the insurance policy has been transferred to an account controlled by the one or more processors.

At operation 315, the computing device 100 in accordance with the rider received at operation 305, forwards the payout to a cryptocurrency custodian that converts the payout into one or more digital assets held in an account on behalf of the at least one beneficiary of the insurance policy. The digital assets may be stored on a blockchain, a digital wallet, physical ledger, etc.

It is to be understood that the computer-implemented method of FIG. 3 is not limited to the operations discussed herein above and may include other operations. For example, the collection of the over-premium payments that are forward to a cryptocurrency custodian into digital assets may also be performed.

With regard to all of the embodiments, the insurance policy may be stored on the blockchain, and alternatively or in addition thereto may be stored in a consumer digital asset wallet as an NFT. In addition, there may digital assets incentives in which risk reduction, behavior modification, and cash conversion are tracked, paid in cash then converted to digital assets for policy holders in accordance with a rider.

With regard to incentives and behavior modification, the tracking of steps and stack sats (Satoshis) via a smart phone app or wearable device track daily steps to earn insurance cash rewards. The cash rewards can be converted to Bitcoin-Satoshis (SAS) or other cryptocurrency or digital assets.

### Storage of Contract on the Blockchain

According to some illustrative embodiments, the contract and any riders for converting the currency to digital assets are stored on the blockchain. For example, Non-Fungible tokens (NFTs) are stored on a blockchain in a similar way to other digital assets, such as cryptocurrencies. However, unlike fungible tokens like Bitcoin or Ethereum, each NFT is unique and cannot be exchanged on a one-to-one basis with other NFTs.

The following operations illustrate one way that NFTs may be stored on a blockchain:
Creation: An NFT is created by a smart contract on the blockchain. The smart contract defines the unique attributes of the NFT, such as its name, description, image, and other metadata.
Minting: The NFT is then minted by a user who pays the required fees to the network. This process creates a unique digital signature that represents the NFT and links it to the blockchain.
Storage: The NFT is then stored on the blockchain, usually in the form of a transaction on the blockchain's ledger. This transaction contains all the information about the NFT, including its unique digital signature.
Ownership: The ownership of the NFT is then recorded on the blockchain's ledger. This recordation of ownership of the NFT enables tracing back to the original owner, and all subsequent transactions involving the NFT are recorded on the blockchain.
Transfer: NFTs can be transferred between owners by creating a new transaction on the blockchain's ledger that updates the ownership of the NFT. This transaction is also stored on the blockchain and can be traced back to the original owner of the NFT.

In summary, NFTs are stored on a blockchain using smart contracts and transactions that record their unique attributes, ownership, and transfer history. This process makes it possible to verify the authenticity and ownership of NFTs, as well as track their movement between owners.

Creating an NFT from a Life Insurance Policy

The creation of an NFT from a life insurance policy and storing the policy on a blockchain includes several operations. A non-limiting overview of the operations performed includes:

Determine the policy details: A first step would be to determine the details of the life insurance policy that is to be tokenized. This determination would include information such as the policy holder's name, the coverage amount, the policy term, and any other relevant details.

Create the NFT smart contract: Once the policy details are determined, a smart contract may be created on the blockchain. The smart contract defines the unique attributes of the NFT, such as its name, description, image, and other metadata. The smart contract also preferably includes the policy details and other relevant information.

Mint the NFT: After the smart contract is created, the NFT is minted. This minting includes creating a unique digital signature that represents the NFT and linking the unique digital signature to the smart contract on the blockchain.

Store the NFT on the blockchain: The NFT is then stored on the blockchain in the form of a transaction that contains all the information about the NFT, including its unique digital signature and the policy details.

Record ownership and transfer: The ownership of the NFT is recorded on the blockchain's ledger. This recording of ownership of the NFT enables tracing back to the original owner, and all subsequent transactions involving the NFT are recorded on the blockchain. If the policy is sold or transferred to a new owner, this transfer would also be recorded on the blockchain.

Verify the authenticity of the NFT: To verify the authenticity of the NFT, a verification operation to ensure the policy details and other information match the information stored on the blockchain. This verification operation may be performed comparing the information on the blockchain with the policy documents or other records.

Overall, creating an NFT from a life insurance policy and storing it on a blockchain is to be performed with careful attention to detail and a thorough understanding of both blockchain technology and the details of the life insurance policy. There is to be compliance with any relevant legal and regulatory requirements.

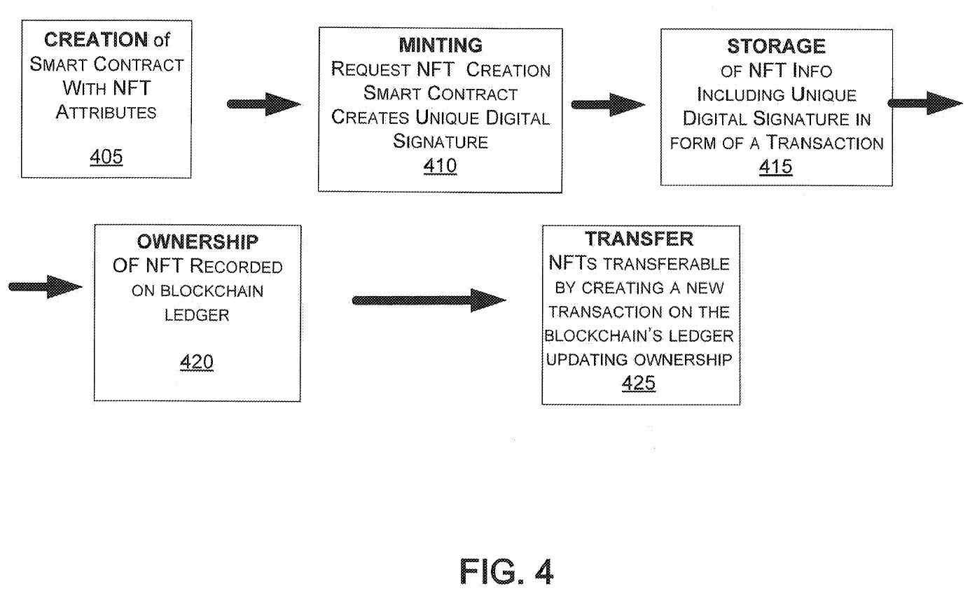

FIG. 4 is a process flow of how NFTs are created and stored on a blockchain. Referring now to FIG. 4, this flow includes:

Operation 405, Creation: A smart contract is created on the blockchain that defines the unique attributes of the NFT, such as its name, description, image, and other metadata.

Operation 410, Minting: A user requests the creation of an NFT by interacting with the smart contract. The smart contract creates a unique digital signature that represents the NFT and links it to the blockchain.

Operation 415, Storage: The NFT is stored on the blockchain in the form of a transaction that contains all the information about the NFT, including its unique digital signature.

Operation 420, Ownership: The ownership of the NFT is recorded on the blockchain's ledger. This means that the ownership of the NFT can be traced back to the original owner, and all subsequent transactions involving the NFT are recorded on the blockchain.

Operation 425, Transfer: NFTs can be transferred between owners by creating a new transaction on the blockchain's ledger that updates the ownership of the NFT.

It is to be understood that FIG. 4 is provided for purposes of illustration and does not limit the scope of present disclosure and the appended claims. There may be additional steps or complexities depending on the specific blockchain and NFT implementation.

While several illustrative embodiments of the present disclosure have been shown and described, numerous variations and alternative embodiments will occur to those skilled in the art. Such variations and alternative embodiments are contemplated, and can be made without departing from the scope of the present disclosure as defined in the appended claims.

As used in this specification and the appended claims, the singular forms “a,’ ‘an,” and “the” include plural referents unless the content clearly dictates otherwise. The term plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the present disclosure to the precise form(s) described, but only to enable others skilled in the art to understand how the present disclosure may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the present disclosure be defined by the claims as written and equivalents as applicable. Reference to a claim element in the singular is not intended to mean “one and only one′, unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, paragraph (f), unless the element is expressly recited using the phrase “means for. and no method or process step herein is to be construed under those provisions unless the step, or steps, are expressly recited using the phrase” step(s) for . . . .”

What is claimed is:

1. A computer-implemented method of converting currency into digital assets, the method comprising:
obtaining, by a computing device, an authorization to receive an electronic payout in a fiat coin or currency of a first predetermined amount on behalf of at least one beneficiary of an insurance policy;
receiving the payout and converting the electronic payout of fiat coin or currency of the first predetermined amount into one or more digital assets of the payout;
providing the at least one beneficiary with one or more payments of a second predetermined amount.

2. The method according to claim 1, wherein the obtaining of authorization to receive the payout in the first determined amount and convert the payout into digital assets is provided by an executed a rider to an existing insurance policy.

3. The method according to claim 2, wherein the existing insurance policy and the executed rider is stored on a blockchain.

4. The method according to claim 2, wherein the existing insurance policy and the executed rider is stored as a non-fungible token (NFT) in a consumer digital asset wallet.

5. The method according to claim 1, wherein the obtaining of authorization to receive the payout in the first determined amount and convert the payout into digital assets is provided by an executed a rider to a new insurance policy.

6. The method according to claim 5, wherein the new insurance policy and the executed rider is stored on a blockchain.

7. The method according to claim 5, wherein the new insurance policy and the executed rider is stored as a non-fungible token (NFT) in a consumer digital asset wallet.

8. The method according to claim 1, wherein the digital assets of the payout are stored in one or more blockchains.

9. The method according to claim 1, wherein the digital assets of the payout are stored in a digital wallet.

10. The method according to claim 1, further comprising:
receiving one or more over-premium payment amounts from an insurance company or its designee for the at least one beneficiary of the insurance policy, and
converting the one or more over-premium payments into digital assets of the over-premium payment amounts held in a respective account created for the at least one beneficiary, and
adding to the second predetermined amount a current value of the received one or more over-premium payments when providing the at least one beneficiary with one or more payments.

11. The method according to claim 10, wherein the receiving of one or more over-premium payments from the insurance company or its designee comprises policy owner over-premium payments.

12. The method according to claim 1, wherein the providing of the at least one or more payments of the second predetermined amount is performed in response to a request of the at least one beneficiary or the owner of the insurance policy, and
wherein the second predetermined amount comprises one of a fraction, a percentage, or a fixed amount that is less than the first predetermined amount.

13. The method according to claim 1, wherein the providing of the second predetermined amount comprises providing a lump sum payout substantially equal to the first predetermined amount.

14. The method according to claim 1, wherein the converting of the payout into digital assets comprises electronically sending the fiat coin or currency to a cryptocurrency qualified custody account and requesting conversion of the fiat coin or currency into at least one designated cryptocurrency and/or a non-fungible token (NFT).

15. The method according to claim 1, wherein the converting of the payout into digital assets includes electronically communicating instructions and the payout of the first predetermined amount of fiat coin or currency to a cryptocurrency custodian to convert the fiat coin or currency into cryptocurrency.

16. The method according to claim 1, wherein the converting of the payout into digital assets comprises converting the fiat coin or currency payout into one or more of Bitcoin, Litecoin, or Non-Fungible Tokens.

17. The method according to claim 1, wherein the providing of the one or more payments to the beneficiary are made in a fiat coin or currency.

18. The method according to claim 1, wherein the providing of the one or more payments to the beneficiary is made in a cryptocurrency.

19. The method according to claim 1, further comprising providing digital assets incentives in which risk reduction, behavior modification, and cash conversion are tracked, paid in cash then converted to digital assets for policy holders in accordance with a rider to the insurance policy.

20. A computer-implemented method of currency conversion into digital assets, the method comprising:
receiving by one or more processors an electronic communication including a rider to an insurance policy that authorizes receiving a payout in a fiat coin or currency of a first predetermined amount on behalf of at least one beneficiary of an insurance policy;
receiving an indication that the payout from the insurance policy has been transferred to an account controlled by the one or more processors; and
forwarding the payout from to a cryptocurrency exchange that converts the payout into one or more digital assets held in an account on behalf of the at least one beneficiary of the insurance policy.

21. The computer-implemented method according to claim 20, wherein the cryptocurrency custodian stores the digital assets in a digital wallet, and further comprising sending by an insurtech entity over-premium payments to the cryptocurrency custodian for conversion to digital assets and holding in the account on behalf of the at least one beneficiary of the insurance policy.

22. The computer-implemented method according to claim 20, wherein the cryptocurrency custodian stores the digital assets of the payout in a blockchain, and further comprising sending by an insurtech entity over-premium payments to the cryptocurrency custodian for conversion to digital assets of the over-premium payments and storing in the account on behalf of the at least one beneficiary of the insurance policy.

23. The computer-implemented method according to claim 20, wherein the cryptocurrency custodian electronically sends the digital assets to an insurtech entity for storage online in a digital wallet or offline in an electronic ledger.

24. The computer-implemented method according to claim 20, further comprising:
in response to receiving a request from the at least one beneficiary, providing one or more payments of a predetermined amount from the account held on behalf of the at least one beneficiary of the insurance policy.

25. The computer-implemented method according to claim 20, further comprising:
in response to receiving a request from the at least one beneficiary, providing one or more payments of a predetermined amount from the account held on behalf of the at least one beneficiary of the insurance policy.

26. A computing device for converting currency into digital assets, the computing device comprising:
one or more processors;
a memory coupled to the processor, the memory storing non-transitory executable instructions to cause the processor to perform acts comprising:
obtaining an authorization to receive a payout in a fiat coin or currency of a first predetermined amount on behalf of at least one beneficiary of an insurance policy;
receiving the payout and converting the first predetermined amount into one or more digital assets; and
providing the at least one beneficiary with one or more payments of a second predetermined amount based on a current value of the one or more digital assets.

27. The computing device according to claim 26, wherein the obtaining an authorization to receive a payout in the fiat coin or currency comprises receiving an electronic rider including instructions identifying an insurance policy and the at least one beneficiary of the insurance policy authoring conversion to the one or more digital assets.

28. The computing device according to claim 26, wherein the instructions cause the processor to perform additional acts comprising:
receiving one or more over-premium payment amounts from an insurance company or its designee for the at least one beneficiary of the insurance policy, and
converting the one or more over-premium payments into digital assets held in a respective account created for each of the at least one beneficiary, and
adding to the second predetermined amount a current value of the received one or more over-premium payments when providing the at least one beneficiary with one or more payments.

29. The computing device according to claim 28, wherein the converting of the payout into digital assets includes executable instructions to cause the one or more processors to perform additional acts including electronically communicating instructions and providing the payout of the first predetermined amount of fiat coin or currency to a cryptocurrency custodian to convert the fiat coin or currency into cryptocurrency.

30. The computing device according to claim 28, wherein the converting of the payout into digital assets comprises converting the fiat coin or currency into one or more designated cryptocurrencies and/or a non-fungible token (NFT).

31. A non-transitory computer-readable storage medium tangibly embodying a computer-readable program code having computer-readable instructions that, when executed, causes a computer device to carry out a method of the method comprising:
obtaining authorization to receive a payout in a fiat coin or currency of a first predetermined amount on behalf of at least one beneficiary of an insurance policy;
receiving one or more over-premium payment amounts from an insurance company or its designee for the at least one beneficiary of the insurance policy and converting the over-premium payment amounts amount into one or more digital assets of the payout held in a respective account created for each of the at least one beneficiary;
receiving the payout in a fiat coin or currency of a first predetermined amount on behalf of at least one beneficiary of an insurance policy and converting the first predetermined amount of the payout into the one or more digital assets;
in response to receiving a request, providing the at least one beneficiary with one or more payments of a second predetermined amount that includes a least a portion of the over-premium payments converted into digital assets, and the payout of the insurance policy converted into a form of one or more of a cryptocurrency and/or a fiat coin currency.

32. The non-transitory computer-readable storage medium of claim 31, further comprises instructions to causes a computer device to store the digital assets of the payout and the over-premium payments in a blockchain.
